(19) United States
(12) Patent Application Publication
(10) Pub. No.: US 2008/0174154 A1
(43) Pub. Date: Jul. 24, 2008

(54) VEHICLE HEAD RESTRAINT WITH SUPPORT MEMBER MOUNTED BETWEEN LEG PORTIONS

(75) Inventors: Eric Langensiepen, Beverly Hills, MI (US); Mike Golin, Dexter, MI (US)

Correspondence Address: EDWARDS ANGELL PALMER & DODGE LLP, P.O. BOX 55874, BOSTON, MA, 02205, US

(73) Assignee: KONGSBERG AUTOMOTIVE AB, Mullsjo (SE)

(21) Appl. No.: 11/937,887

(22) Filed: Nov. 9, 2007

Related U.S. Application Data
(60) Provisional application No. 60/876,097, filed on Dec. 19, 2006.

(51) Int. Cl. B60N 2/48; A47C 7/38

(52) U.S. Cl. 297/216.12; 29/91.1

(57) ABSTRACT

A head restraint includes a head restraint post having at least a pair of leg portions, a cross member interconnecting the leg portions, and a rigid support member connected to the cross member of the post without retaining the leg portions, where the rigid support member does not rotate about the cross member. By virtue of the rigid support member being connected to the cross member without retaining the leg portions, the leg portions are provided with sufficient flexibility for easy assembly with a seat back and smooth height adjustment. A compressible pad further can be arranged over the post and rigid support member to complete manufacture of the head restraint. The leg portions of the head restraint are configured to be received in at least one of a seat back, an interface in the seat back, or another part of a motor vehicle.

### CROSS-REFERENCE TO RELATED APPLICATION

This application claims the benefit of copending application U.S. Provisional Application Ser. No. 60/876,097 filed on Dec. 19, 2006, the disclosure of which is expressly incorporated herein by reference in its entirety.

### FIELD OF INVENTION

The present invention relates to a vehicle head restraint configured for attachment to a seat back, and more particularly to a rigid support member of the head restraint mounted such that the rigid support member does not retain leg portions of the head restraint, the leg portions of the head restraint thereby remaining flexible for convenient assembly with the seat back and smooth height adjustment of the head restraint after assembly.

### BACKGROUND OF THE INVENTION

Vehicle head restraints typically are designed to fulfill safety requirements and be comfortable for occupants. Head restraints also should be designed for ease of manufacture and assembly to seat backs. One problem encountered during manufacture and assembly relates to the dimensional relationship of leg members that interface with the seat back attachment. In order for the head restraint to properly engage with the seat back, leg members of the head restraint must be designed with an appropriate interfacing tolerance to be received in the seat back, while still fulfilling safety requirements of providing rigid support during use to prevent injuries to occupants, such as whiplash injuries.

It is known to include a steel rod or tube for forming a post in a head restraint, where the post can have an inverted U-shape or a serpentine loop (M-shape) in order to support different occupants. Typically such head restraints include a single layer of foam covering the post. It is also known to provide an additional rigid support member attached to or integrated with the post to improve head support. Examples of references disclosing a rigid support member attached or made integral with a post include U.S. Patent Application Publication US 2005/0127734 to Veine et al. and U.S. Pat. No. 6,880,891 to Yetukuri et al.

In prior art head restraints that include a rigid support member integrated with a post, the “rigid support member” is referred to using different terms such as: core, insert, member, armature, or structure (hereinafter collectively referred to as a “rigid support member”). The reason for providing a rigid support member is that head restraints with only foam covering the post generally provide too small a support zone to give adequate support to a wide range of occupants and seating positions. As a result, during an accident, an occupant may suffer head-to-neck rotation that can cause additional soft tissue damage in the neck.

However, after attachment of a rigid support member to the post, prior art head restraints generally are not sufficiently flexible to overcome any tolerance problems in the leg portions, where the leg portions must be precisely manufactured to fit within corresponding holders in a seat back. The rigid support member must always be prevented from rotating around the cross bar member of the post, in order to carry out head restraint functions. The rigid support member is therefore commonly fixed to the deflection points and/or the leg portions of the post. As a result the leg portions become substantially inflexible. As used herein, the term “deflection point” refers to a point or region of the post that bends, as distinguished from generally straight portions thereof. The inflexibility of the leg portions of the head restraint post prevents adjustment or movement of the leg portions prior to assembly the head restraint with the seat back, which can result in head restraint devices that do not fit within corresponding holders of a seat back or that friction between the holder in the seat back and the head restraint post causes unwanted noise and/or adjustment operation difficulties (jam). The result is that prior art head restraints often do not fit within their respective holders, or do not adjust properly, resulting in the need to discard or rework the head restraint in each instance.

Another example of a prior art device is U.S. Pat. No. 5,257,853 to Elton et al. (“Elton”), which teaches a member fitted to a cross bar that does not retain the deflection points or the leg portions of the posts. In Elton, the member fitted to the post is allowed to rotate freely around the cross bar and can therefore not be considered a rigid support member. Devices such as those disclosed in Elton do not satisfy appropriate safety requirements, and thus cannot be considered head restraints. Instead, such prior art devices merely serve as headrests and belong to a different field of technology because the member used for interfacing the head in such prior art devices merely provides comfort to the head but does not satisfy safety requirements.

In prior art head restraints which include a rigid support member that covers, encloses, surrounds, locks, or is otherwise attached or connected to multiple deflection points and/or leg portions of the post, to prevent rotation of the rigid support member, the leg portions of the head restraint generally do not have sufficient flexibility to interface properly with the seat back, or do not permit smooth height adjustment of the head restraint during use. In other words, after molding or fixation of the rigid support member to the post of prior art head restraints, the leg portions become substantially unbendable and tolerance problems arise from this inflexibility, which leads to the drawbacks discussed above.

It would be desirable to provide a vehicle head restraint having a rigid support member attached to a head restraint post that is secured against rotation but where the leg portions of the post after attachment of the rigid support member maintain their flexibility and original interfacing tolerances to overcome the above-mentioned drawbacks of prior art head restraints. The vehicle head restraint and related methods of manufacturing and using the head restraint should overcome the deficiencies of the presently available methods and systems.

### SUMMARY OF THE INVENTION

A vehicle head restraint assembly or device, referred to herein as a “head restraint,” according to the present invention includes a head restraint post having at least a pair of leg portions, a cross member interconnecting the leg portions, and a rigid support member connected to the post. The post can form an inverted U-shape, a serpentine loop (M-shape), an inverted M-shaped loop, or any other suitable form, where each bend in the post can be referred to as a “deflection point.” The rigid support member preferably is connected to the cross member without covering at least two deflection points, more preferably without covering the outermost deflection points of the post.

According to the present invention, the rigid support member is connected to the cross member without retaining the leg portions of the post, thereby providing the leg portions with sufficient flexibility during assembly to interface properly with corresponding holders of a seat back, and enabling smooth height adjustment during use. In particular, after assembly, the head restraint can be adjusted with ease without causing unwanted noise between the head restraint post and the seat back holders. Alternatively, the head restraint can be assembled directly to the motor vehicle itself, with or without a height adjustment capability.

The rigid support member must not rotate about the cross member in case the head of an occupant impacts with the head restraint, where such rotation would negatively affect the head restraining ability of the head restraint. The M-shaped loop configurations can prevent rotation of the rigid support member by virtue of their design. Alternatively, if an inverted U-shaped loop is used, the rigid support member can be formed with additional base portions for engaging but not retaining the leg portions, which can prevent rotation of the rigid support member.

According to the present invention, the rigid support member is connected to the cross member between the leg portions, and preferably between at least two deflection points, more preferably between the outermost deflection points; however, the rigid support member remains unconnected to the deflection points themselves, and is not retained or fixedly attached to the leg portions. In this manner, the rigid support member is connected to the cross member without covering the at least two deflection points and without retaining the leg portions. The rigid support member preferably can be molded to the post, and the present invention encompasses a method of manufacturing the head restraint with suitable tolerances for assembly with a seat back, where the dimensions of the leg portions remain substantially constant before and after the manufacturing process.

The head restraint includes a rigid support member encased with or within a compressible pad, for example, made of a comfort foam. The compressible pad preferably covers substantially the entire rigid support member and the cross member, and extends a suitable distance over the leg portions of the head restraint.

The head restraint post is formed with a plurality of bends or deflection points, typically at least two deflection points which are the two outermost deflection points that transition to the leg portions. For example, a head restraint post formed as an M-shaped loop can include three deflection points, including two outermost deflection points and one inner deflection point. According to the present invention, the rigid support member preferably is attached to the cross member between at least two of the deflection points without covering the at least two deflection points. The uncovered deflection points preferably are the outermost deflection points located near or adjacent to the leg portions of the post, and the rigid support member must not be fixedly attached to the leg portions. Since at least two deflection points are not covered or connected to the rigid support member, and the leg portions are not retained by the rigid support member, the leg portions of the head restraint maintain their flexibility to facilitate assembly of the head restraint to a seat back.

Also, the rigid support member does not rotate about the M-shaped loop because of its design, thus providing suitable head restraining ability to the head restraint during use. Finally, because the leg portions are not retained by the rigid support member, the leg portions do not maintain an internal tension or stress relative the seat back, which ensures low friction and noise-free height adjustment of the head restraint.

The leg portions are configured to be received in at least one of a seat back, an interface in the seat back, or any other suitable location in a motor vehicle such as a car or truck. Further, the present invention can be used with different types of adjustment mechanisms, and also with mechanisms that are non-adjustable.

According to a method of manufacturing the head restraint, the rigid support member is connected to the cross member of the post without retaining the leg portions and without rotating about the cross member, and the rigid support member and the post are inserted into a trim bag. The rigid support member and the post can be inserted into the trim bag easily because the rigid support member preferably has a smaller width than the leg portions and/or deflection points of the post, thereby allowing the bag to be slipped over the rigid support member and the post. Thereafter, a foaming process can be undertaken in which foam or another padding material is injected into a cavity of the trim bag to form a compressible pad. Because the dimensions of the leg portions remain substantially constant before and after the attachment of the rigid support member and the foaming process, the leg portions are provided with suitable tolerances for assembly with a seat back, resulting in fewer discarded units.

According to the present invention, the head restraint can be configured for use with various seat back constructions, for example, by modifying spacing between the leg portions. Thus, the structural dimensions of the head restraint are modular, in that the spacing between the leg portions can be modified or adjusted.

In certain embodiments, the cross member can be configured as a serpentine loop or an inverted M-shaped loop, where the rigid support member has a width smaller than the width of at least two deflection points, thereby facilitating manufacturing of the head restraint using a trim bag, for example.

In at least one other embodiment, the rigid support member includes base portions that engage, that is, touch but do not retain leg portions of the post. This embodiment can utilize a U-shaped post that includes a rigid support member that is secured against rotation because the base portions of the rigid support member are configured to touch the leg portions of the post and thus cannot rotate about the post.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is a rear perspective view of a head restraint post engaged with a seat back;

FIG. 2A is a front perspective view of a head restraint of the present invention incorporating the head restraint post of FIG. 1;

FIG. 2B is an enlarged front perspective view of the head restraint of FIG. 2A;

FIG. 3 is a cross-sectional front view of the head restraint of FIG. 2B;

FIG. 4 is a cross-sectional front view of the head restraint of FIG. 3 including an alternate arrangement of the leg portions;

FIG. 5 is a front perspective view of a head restraint according to another preferred embodiment of the present invention;

FIG. 6 is a front perspective view of a head restraint according to a further preferred embodiment of the present invention; and

FIG. 7 is a schematic front view of a head restraint according to the present invention, and further including a compressible pad.

### DEFINITIONS

The instant invention is most clearly understood with reference to the following definitions:

As used in the specification and claims, the singular form “a”, “an” and “the” include plural references unless the context clearly dictates otherwise.

As used herein, the term “vehicle head restraint” refers to a device or assembly for supporting the head of an occupant or passenger, the vehicle head restraint possibly including a rod or post formed with one or more leg portions configured for assembly to a motor vehicle, a rigid support member, and optionally one or more additional components. The term “head restraint” is used interchangeably with “vehicle head restraint.”

As used herein, the term “deflection point” refers to a point or area of the post with a bend, as distinguished from the generally straight portions.

### DETAILED DESCRIPTION OF THE INVENTION

A head restraint according to the invention includes a head restraint post having at least a pair of leg portions and a cross member interconnecting the leg portions, the post being formed with a plurality of deflection points. The head restraint also includes a rigid support member connected to the cross member of the post without retaining the leg portions, where the rigid support member does not rotate about the cross member. Preferably the rigid support member does not cover at least two deflection points of the post, more preferably the outermost deflection points. The post can be formed as a serpentine loop (M-shape), an inverted M-shaped loop, or another design such as an inverted U-shaped loop. The post can be made of any suitable material, such as metal and/or plastic. The post preferably is detachably engaged with the seat back by inserting the leg portions of the post into a pair of holders fixedly arranged on a top portion of the seat back. Lower ends of the leg portions are configured to support the head restraint on top of a seat backrest. The leg portions can be received in at least one of a seat back, an interface in the seat back, and any other suitable location in a motor vehicle such as a car or truck.

According to the invention, the rigid support member of the head restraint does not retain the leg portions. Preferably the rigid support member is connected to the cross member without covering or being connected to at least two deflection points, more preferably the outermost deflection points, such that the leg portions are provided with sufficient flexibility for assembly with a seat back. The rigid support member can be molded to the post, and the present invention encompasses a method of manufacturing the head restraint with suitable tolerances for assembly with a seat back, where the dimensions of the leg portions remain substantially constant before and after the manufacturing process. According to the invention, the rigid support member does not rotate about the cross member. A head restraint incorporating the rigid support member according to the present invention has suitable head restraining abilities during use.

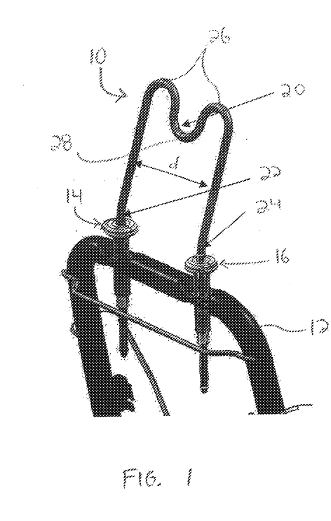

Referring to FIG. 1, a head restraint post 10 is shown attached to a seat back 12, where the seat back 12 is used for supporting a vehicle seat provided in a motor vehicle such as a car, truck, construction vehicle, or any other vehicle. The seat back 12 is formed with at least a pair of holders 14 and 16 for receiving leg portions of the head restraint post 10. The holders 14 and 16 preferably are fixedly arranged on a top portion of the seat back 12, and each holder includes a hole for receiving a corresponding leg portion of the post.

The head restraint post 10 includes one or more leg portions, preferably a pair of leg portions 22 and 24, the leg portions 22 and 24 configured to be received in the holders 14 and 16, respectively. The leg portions 22 and 24 are separated by a distance d, where this distance or width can vary based on the distance between the holders 14 and 16 of a particular seat back 12.

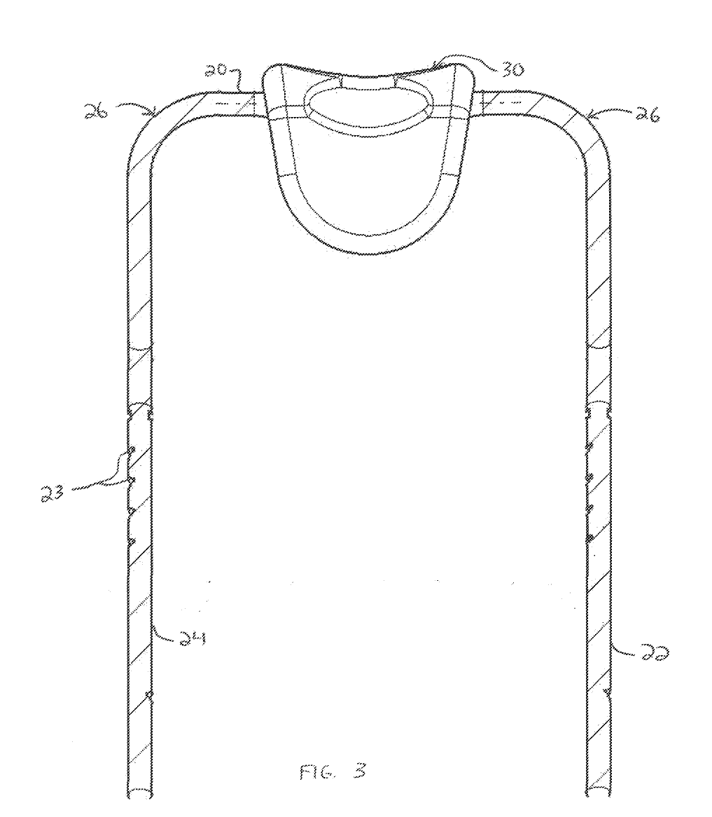

The leg portions 22 and 24 preferably include a plurality of notches 23 (see FIG. 3) for adjusting the height of the leg portions 22 and 24 relative to the holders 14 and 16. In other words, by virtue of the notches 23 provided on the leg portions 22 and 24, the head restraint post 10 and thus the head restraint itself is adjustable to a plurality of heights as selected by the occupant.

The head restraint post 10 depicted in FIG. 1 includes the leg portions 22 and 24, and further includes a cross member 20 interconnecting the leg portions 22 and 24. The cross member 20 can be straight and/or curved, depending on the particular shape of the post 10. For example, the leg portions 22 and 24, and the cross member 20 in FIG. 1 form a serpentine loop (M-shape), but in other embodiments the post may have a different form, such as an inverted M-shape or an inverted U-shape. As shown in FIG. 1, in accordance with the shape of the post 10, there are formed a plurality of bends or deflection points, such as a pair of deflection points 26 which are outermost deflection points corresponding approximately to peaks of the post 10, and thus marking an approximate delineation between the cross member 20 and the leg portions 22 and 24. An inner deflection point 28 marks approximately a valley of the cross member 20. By virtue of the M-shaped design, a rigid support member mounted on the post is substantially prevented from rotation, and thus maintains suitable head restraining properties.

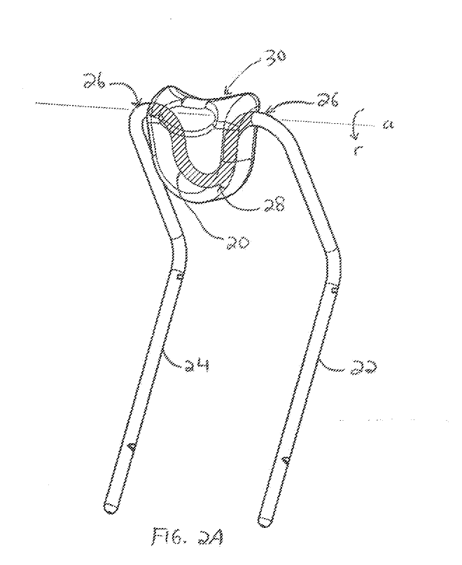

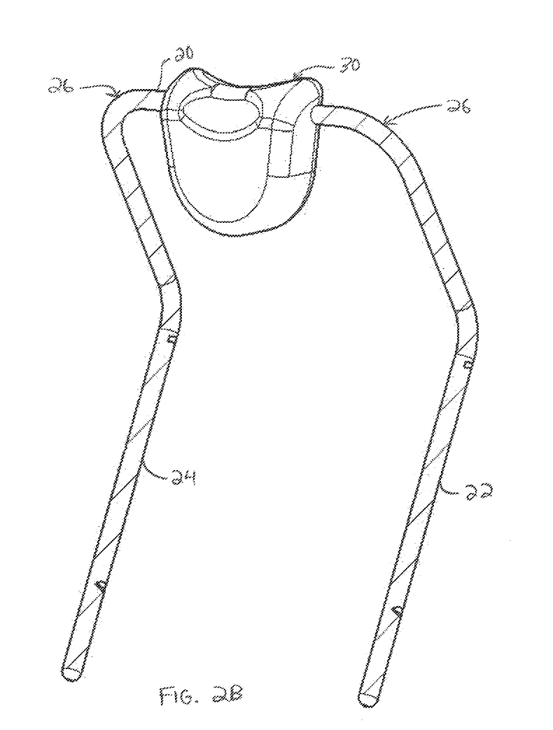

Referring to FIGS. 2A-2B and 3, a rigid support member 30 is connected to the cross member 20 of the head restraint post 10. The rigid support member 30 does not retain the leg portions 22 and 24, and preferably is not connected to, and does not cover, enclose, or surround the pair of outermost deflection points 26. In other words, the rigid support member 30 is fixed to the post 10 without retaining the leg portions, and preferably without being connected to and without covering at least two of the deflection points. Additionally, the rigid support member 30 may cover the deflection point 28 marking the valley of the cross member 20, which can enhance stability, but does affect flexibility of the leg portions prior to assembly with a seat back.

Preferably the rigid support member 30 is molded to the cross member 20 during a manufacturing process. Alternatively, the rigid support member 30 may be fixed to the cross member 20 using any other suitable mechanism. The rigid support member 30 preferably can be made of plastic or any suitable composite material. The use of such a rigid support member in conjunction with the post can reduce forces and moments on the occupant's neck and reduce head rotation relative to the torso. The rigid support member can be sized appropriately in accordance with the dimensions of the post.

The rigid support member 30 is connected to the post 10 such that the rigid support member 30 preferably is not molded to and does not cover at least two deflection points of the post, and where the rigid support member 30 does not retain the leg portions 22 and 24. By virtue of this construction, the head restraint is provided with substantial flexibility during assembly, and thus the leg portions are capable of being adjusted or moved prior to assembly with a seat back.

The rigid support member 30 also does not rotate about the cross member 20. This non-rotation of the rigid support member 30 is critical to proper functioning of the head restraint in order to meet safety requirements. Referring to FIG. 2A, a horizontal axis a is depicted, where the axis a generally marks an imaginary line connecting the pair of outermost deflection points 26. The rigid support member 30 cannot rotate in the direction of arrow r about the axis a by virtue of M-shaped design of the cross member 20. As a result, if an occupant's head is thrust backwardly into the head restraint, the rigid support member 30 will not rotate in the direction of the arrow r.

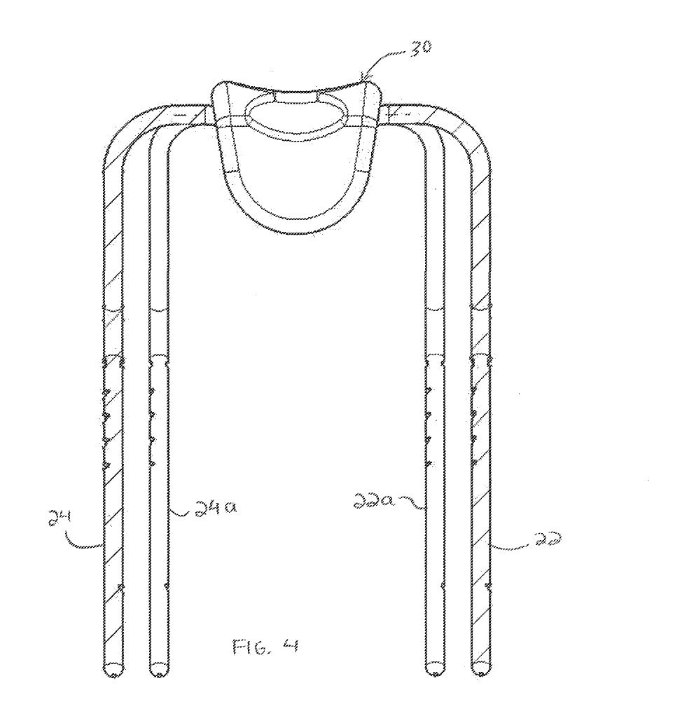

FIG. 4 depicts an alternate arrangement of the leg portions of the post, where the leg portions 22 and 24 can be replaced with leg portions 22a and 24a, respectively. A head restraint according to the present invention preferably has a modular construction, such that the spacing between the leg portions can be modified or adjusted to provide an optimum spacing for particular applications. Even in the modified positions of the leg portions 22a and 24a, the rigid support member 30 functions in the same manner, thus providing a head restraint that satisfies safety requirements during use, but enables the leg portions to remain flexible during assembly.

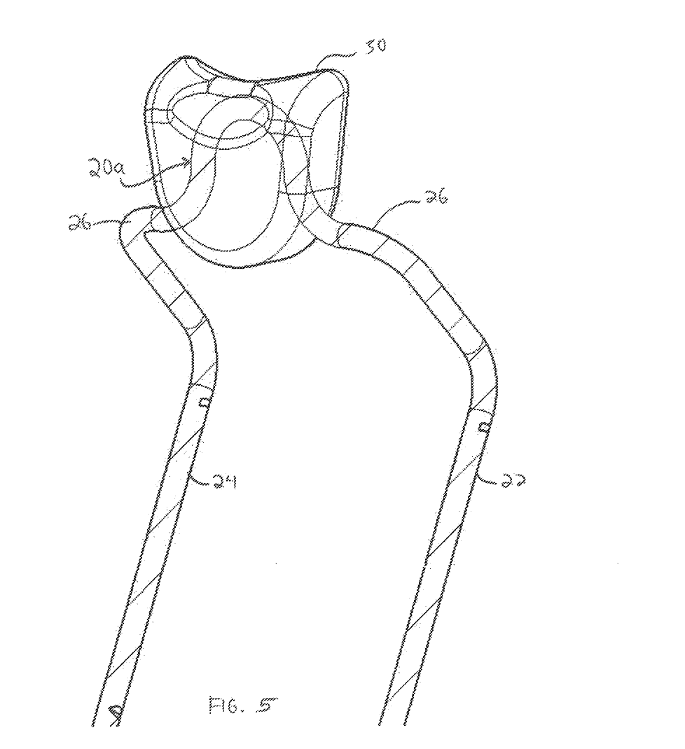

A head restraint according to another preferred embodiment is depicted in FIG. 5, where the rigid support member 30 is mounted to a cross member 20a in the form of an inverted M-shaped loop. In this embodiment, the rigid support member 30 is connected to the cross member 20a between at least two deflection points 26, but does not cover or otherwise connect to the outermost deflection points 26. Also, the rigid support member 30 does not retain the leg portions 22 and 24. Such a design allows the leg portions 22 and 24 to remain suitably flexible for assembly to a seat back, and for smooth height adjustment after assembly.

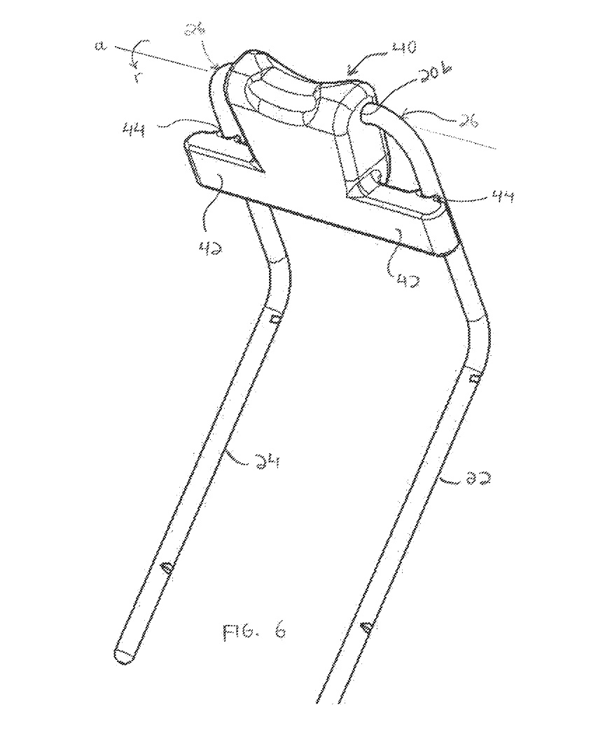

A head restraint according to a further preferred embodiment is depicted in FIG. 6, where an alternate rigid support member 40 is mounted to a cross member 20b in the form of an inverted U-shaped post. In this embodiment, the rigid support member 40 is connected to the cross member 20b between at least two deflection points 26, but without covering or otherwise being connected to the outermost deflection points 26. Also, in this embodiment, the rigid support member 40 includes base portions 42 having engagement areas 44 configured to engage or touch but not retain the leg portions 22 and 24.

The cross member 20b has an axis a approximating the top horizontal extent of the cross member 20b, where the rigid support member 40 does not rotate about the cross member 20b. In particular, the design of FIG. 6 allows the rigid support member 40 to be secured against rotation because the engagement areas 44 of the base portions 42 are configured to touch the leg portions 22 and 24 of the post and thus cannot rotate about the post. Because the rigid support member 40 only touches but does not retain the leg portions, the leg portions can remain suitably flexible for assembly to a seat back, and for smooth height adjustment after assembly.

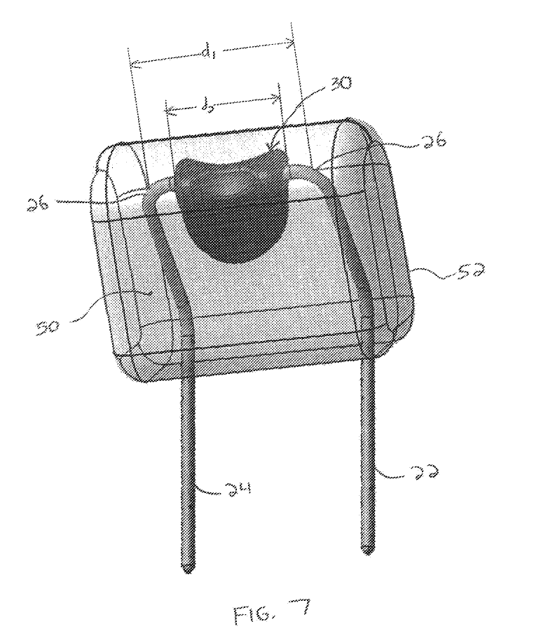

Referring to FIG. 7, a rigid support member 30 such as that described in FIGS. 2 to 5, for example, preferably has a width or horizontal distance d₂ that is less than the width or horizontal distance d₁ between the pair of outermost deflection points 26, such that by virtue of this smaller distance d₂ of the rigid support member 30 and the pair of outermost deflection points 26 remaining uncovered, flexibility of the head restraint leg portions is maintained.

Further, the rigid support member 30 may contact, but does not retain or surround the leg portions 22 and 24 of the post 10, thus providing additional flexibility. The dimensions of the leg portions 22 and 24 thus remain substantially constant before and after a manufacturing process, thus enabling easy assembly with a seat back.

Referring again to FIG. 7, the head restraint further includes a compressible pad 50 that preferably encases the rigid support member 30 and portions of the post 10, in particular the cross member 20. The compressible pad 50 can be made of a foam such as urethane foam, or any other suitable material, where the compressible pad 50 is surrounded or enclosed by a surface skin 52. In case of impact, the compressible pad 50 is compressed, and further head rotation is blocked by the rigid support member when the occupant's head engages the head restraint.

A method of manufacturing a head restraint according to the present invention preferably includes providing a post including a pair of leg portions and a cross member interconnecting the leg portions, the post preferably being formed with at least two deflection points, and connecting the head restraint post with the rigid support member, such as by molding or another process. In particular, the method involves placing the head restraint post in a foam core mold, and then pouring the material used to form the rigid support member in an area between the outermost deflection points of the head restraint post, and curing the material to form the rigid support member. As a result, the head restraint post is fixedly attached to the cross member, but does not cover at least two deflection points of the post, as described above. Thereafter, a foaming process is carried out to encapsulate or surround the head restraint post and rigid support member with comfort foam to produce the compressible pad, which foaming process can be carried out according to one of the following alternative processes.

According to a first foaming process, the post and rigid support member form an assembly that is placed in a foam tool, and then a foam such as a comfort foam is poured around the assembly. Finally, a trim can be assembled over the foam assembly. In the first foaming process, the foam is integrated into the assembly of the post and rigid support member.

According to a second foaming process, the rigid support member and post form an assembly that is positioned within a head restraint trim bag (not shown) via an opening of the trim bag so that foam or another material can be injected into a cavity of the trim bag to substantially fill the cavity. The rigid support member and the post can be inserted into the trim bag easily because the rigid support member preferably has a smaller width than the leg portions or deflection points of the post, thereby allowing the bag to be slipped over the rigid support member and the post. After insertion of the assembly of the rigid support member and the post, the assembly is placed in a foam tool, and a foam such as a comfort foam is poured around the rigid support member and inside the trim bag to form a compressible pad 40 (see FIG. 7). Because the dimensions of the leg portions remain substantially constant before and after the foaming process, the flexibility of the leg portions is maintained, resulting in fewer discarded units.

Moreover, because a trim bag with a relatively small hole is used, it is not necessary to provide any additional close out parts or carry out additional processes after foam is poured into the trim bag. In contrast, trim bags used with prior art head restraints may have rigid support members that extend over the leg portions and/or deflection points of the post, thus requiring large holes in the trim bags which must have an additional close out.

According to a third foaming process, the post and rigid support member form an assembly that is placed in a foam mold, and then a foam such as a comfort foam is poured into the foam mold. Thus, the comfort foam is formed around the assembly. Finally, a trim can be assembled over the foam assembly.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A head restraint, comprising:
a post including at least a pair of leg portions and a cross member interconnecting the leg portions; and
a rigid support member connected to the cross member such that the leg portions are not retained by the rigid support member, and the rigid support member does not rotate about the cross member.

2. The head restraint of claim 1, further including a compressible pad that encases the rigid support member.

3. The head restraint of claim 2, further including a surface skin that surrounds the compressible pad.

4. The head restraint of claim 2, wherein the compressible pad comprises foam.

5. The head restraint of claim 1, wherein the post is configured as a serpentine loop.

6. The head restraint of claim 1, wherein the leg portions are configured to be received in at least one of a seat back, an interface in the seat back, and a motor vehicle.

7. The head restraint of claim 6, wherein the leg portions are substantially flexible prior to assembling the leg portions to the holders of the seat back.

8. The head restraint of claim 6, wherein the leg portions include a plurality of notches for adjusting a height of the leg portions relative to the holders.

9. The head restraint of claim 1, wherein the post is formed with at least two deflection points, and a distance between the at least two deflection points is greater than a width of the rigid support member.

10. The head restraint of claim 1, wherein the rigid support member is molded to the cross member.

11. The head restraint of claim 1, wherein the post is configured as a U-shaped loop.

12. The head restrain of claim 11, wherein the rigid support member is formed with base portions that engage but do not retain the leg portions.

13. The head restraint of claim 1, wherein the post is configured as an M-shaped loop.

14. A motor vehicle seat comprising the head restraint of claim 1.

15. A motor vehicle comprising the head restraint of claim 1.

16. A head restraint, comprising:
a post including at least a pair of leg portions and a cross member interconnecting the leg portions; and
a rigid support member connected to the cross member without retaining the leg portions, wherein the rigid support member does not rotate about the cross member.

17. The head restraint of claim 16, further including a compressible pad that encases the rigid support member.

18. The head restraint of claim 17, further including a surface skin that surrounds the compressible pad.

19. The head restraint of claim 16, wherein the leg portions are configured to be received in holders of a seat back.

20. The head restraint of claim 16, wherein the rigid support member is molded to the cross member.

21. The head restraint of claim 16, wherein the post is formed with at least two deflection points, and a distance between the at least two deflection points is greater than a width of the rigid support member.

22. A method of manufacturing a head restraint, comprising the steps of:
providing a post including at least a pair of leg portions and a cross member interconnecting the leg portions; and
connecting a rigid support member to the cross member without the rigid support member retaining the leg portions, wherein the rigid support member does not rotate about the cross member.

23. The method of claim 22, further comprising steps of:
inserting the post and the rigid support member into a trim bag; and
injecting foam into a cavity of the trim bag to substantially fill the cavity.

24. The method of claim 22, further comprising steps of:
placing the post and the rigid support member in a foam tool; and
pouring foam around the post and the rigid support member.

25. The method of claim 22, further comprising steps of:
placing the post and the rigid support member in a foam mold; and
pouring foam into the foam mold around the post and the rigid support member.

26. The method of claim 22, further comprising a step of:
assembling the leg portions to holders of a seat back.

27. The method of claim 22, wherein the rigid support member is molded to the cross member.

28. The method of claim 22, further comprising a step of:
installing the head restraint in a motor vehicle.

29. The method of claim 22, wherein the post is formed with at least two deflection points, and a distance between the at least two deflection points is greater than a width of the rigid support member.

30. The method of claim 29, further comprising steps of:
inserting the post and the rigid support member into a trim bag; and
injecting foam into a cavity of the trim bag to substantially fill the cavity.
